(19) United States
(12) Patent Application Publication
(10) Pub. No.: US 2024/0286310 A1
(43) Pub. Date: Aug. 29, 2024

(54) WOOD STRUCTURAL PANELS WITH COATING COMBINING FIRE-RESISTANCE AND WATER RESISTANCE

(71) Applicant: LOUISIANA-PACIFIC CORPORATION, NASHVILLE, TN (US)

(72) Inventor: JIANWEN NI, FRANKLIN, TN (US)

(21) Appl. No.: 18/587,320

(22) Filed: Feb. 26, 2024

Related U.S. Application Data
(60) Provisional application No. 63/448,226, filed on Feb. 24, 2023.
(60) Provisional application No. 63/458,486, filed on Apr. 11, 2023.

(51) Int. Cl. B27N 3/04; B27N 3/12; B27N 7/00; B27N 9/00

(52) U.S. Cl. CPC B27N 3/04; B27N 3/12; B27N 7/005; B27N 9/00

(57) ABSTRACT

A multi-layer panel for use as structural sheathing with a coating that is both fire resistant and water resistant. The multi-layer panel may be a wood structural panel, such as OSB or plywood. The coating provides building-code-compliant fire resistance characteristics. The coating also acts as a water resistant barrier (WRB) layer on a surface of the panel. The joint fire-resistant and water-resistant barrier (FR/WRB) coating may be applied to one or both faces of the panel at the manufacturing facility, prior to shipping or installation at a job site. The coating may also be applied to panel edges.

This application claims benefit of and priority to U.S. Prov. App. No. 63/448,226, filed Feb. 24, 2023, and U.S. Prov. App. No. 63/458,486, filed Apr. 11, 2023, both of which are incorporated herein by specific reference in their entireties for all purposes.

### FIELD OF INVENTION

This invention relates to a coating that is both fire resistant and water resistant, for use with a structural panel (which can be wood-based composites, such as oriented strand board (OSB), plywood, or other cellulose-based panel) used for structural sheathing or exterior applications.

### BACKGROUND OF THE INVENTION

Building wall and roof assemblies are layers of several materials, each performing one or more specific functions, that typically are installed separately on the construction sites. Proper installation of the various layers individually and in combination creates challenges not only for the designer, but also for the installers.

A typical layer in most such assembles is a wood panel product, or an integral composite engineered panel product, including, but not limited to, engineered wood composite products formed of lignocellulosic strands (sometimes referred to as oriented-strand board, or OSB). Products such as OSB have been found to be acceptable alternatives in most cases to dimensional lumber or veneer-based wood paneling (e.g., softwood plywood). In general, wood-based composites are produced from wood particles bonded together by an adhesive, the adhesive being selected according to the intended use of, and the properties desired for, the composites. Oftentimes, the adhesive is combined with other additives to impart additional properties to the wood composites. Additives can include fire retardants, insecticides, water repellants, and preservatives. A significant advantage of wood-based composites is that they have many of the properties of plywood, but can be made from lower grade wood species and waste from other wood product production, and can be formed into panels in lengths and widths independent of size of the harvested timber.

A major reason for increased presence in the marketplace of the above-described alternative product is that these materials exhibit properties like those of the equivalent dimension lumber or plywood, especially, the properties of retaining strength, durability, stability and finish under exposure to expected environmental and use conditions. A class of alternative products are multilayer oriented wood strand boards, such as OSB. Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers. The various layers are bonded together by natural or synthetic resins under heat and pressure to make the finished product. Oriented, multilayer wood strand boards of the above-described type are produced with bending, tensile strengths and face strengths comparable to those of commercial softwood plywood. Oriented, multilayer wood strand boards of the above-described type, and examples of processes for pressing and production thereof, are described in detail in U.S. Pat. Nos. 3,164,511, 4,364,984, 5,435,976, 5,470,631, 5,525,394, 5,718,786, and 6,461,743, all of which are incorporated herein in their entireties by specific reference for all purposes.

Building wall and roof assemblies typically are constructed by attaching several panels of the above-described type as to an underlying supporting structure frame as “sheathing.” These sheathing panels are often placed in a pattern forming a substantially continuous flat surface. In certain types of construction, the panels (and other construction materials) may be required under applicable building codes to meet certain fire resistance or water resistance requirements.

In prior art applications, a fire-resistant panel is installed as sheathing at a job or construction site. After installation, a code-approved water-resistive barrier (WRB) system or material is applied. Examples of these WRB systems include housewrap (e.g., Tyvek, Typar), peel-and-stick membranes, or a WRB fluid or liquid applied to the installed panel.

However, these systems all rely upon skilled labor for installation at the job. In addition, many of the systems cannot be installed during inclement weather and require the installed sheathing to be free of defects and provide a clean surface free of debris in order to achieve proper adhesion between the panel and the WRB. As a result, all of these systems can be problematic to install on a job site, and often result in improper installation causing failures in the building “envelope,” leading to problems such as moisture instruction or mold or mildew growth. Examples of installation failures include, but are not limited to, reverse lapping, inconsistent thickness of the liquid applied WRB, and improper adhesion of the WRB to the panel. These prior art systems also increase safety risks at the job site since the installer must handle bulky or clumsy materials at potentially high elevations for long periods of time.

Examples of separate FR and WRB layer systems may be found in U.S. patent application Ser. No. 17/491,367, filed Sep. 30, 2021, and U.S. application Ser. No. 15/365,731, filed Nov. 30, 2016, both of which are incorporated herein by specific reference for all purposes.

Accordingly, what is needed is a wood or wood composite product panel that provides combined fire resistance and water resistance without the need for a WRB system applied at the job or construction site.

### SUMMARY OF INVENTION

In various exemplary embodiments, the present invention comprises a multi-layer panel for use as structural sheathing. The multi-layer panel comprises a wood structural panel, such as OSB or plywood, coated with a product that provides both fire resistance and water resistance. In several embodiments, the treatment provides building-code-compliant fire resistance characteristics. The coating also acts as a water resistive barrier (WRB) layer on a surface of the panel. The invention thus combines a fire-resistant (FR) coating and WRB layer in one multi-layer panel product, which is less reliant on skilled labor for installation at a job site and reduces installation time by eliminating the application of a WRB system in the installation process.

In contrast to the prior art, where a WRB system is separately applied to fire-resistance treated (FRT) sheathing panels at the job site after installation, the present invention applies a joint fire-resistant and water-resistant barrier (FR/WRB) coating to the panel at the manufacturing facility, prior to shipping or installation at a job site, thereby avoiding the problems noted above with regard to prior art systems.

In one embodiment, a fluid or liquid applied coating is applied as the joint FR/WRB via one or more spray nozzles in a manufacturing process. As the panel travels down a secondary production line, the FR/WRB coating is sprayed on the top face of the panel. In some embodiments, the FR/WRB coating also may be applied to the edges of the panel. In some embodiments, the FR/WRB coating is applied to a single face of the panel (i.e., the top face), while in other embodiments, the FR/WRB coating is applied to both faces of the panel.

As a result of this in-line process, the FR/WRB coating is applied at a consistent thickness across the panel. In one exemplary embodiment, the FR/WRB coating is applied at a thickness of from approximately 20 mils to 80 mils. In another exemplary embodiment, the FR/WRB coating is applied at a minimum thickness of approximately 5 mils.

After drying, branding or markings, if any, to be applied to the panel are then applied or printed on the coated surface of the desired face, such as by using a digital printer or other stamping process. This marking also may be performed in the manufacturing line.

### BRIEF DESCRIPTION OF THE DRAWINGS

FIG. 1 shows a view of a sheathing panel installed between framing studs and exterior cladding in accordance with an embodiment of the present invention.

### DETAILED DESCRIPTION OF EXEMPLARY EMBODIMENTS

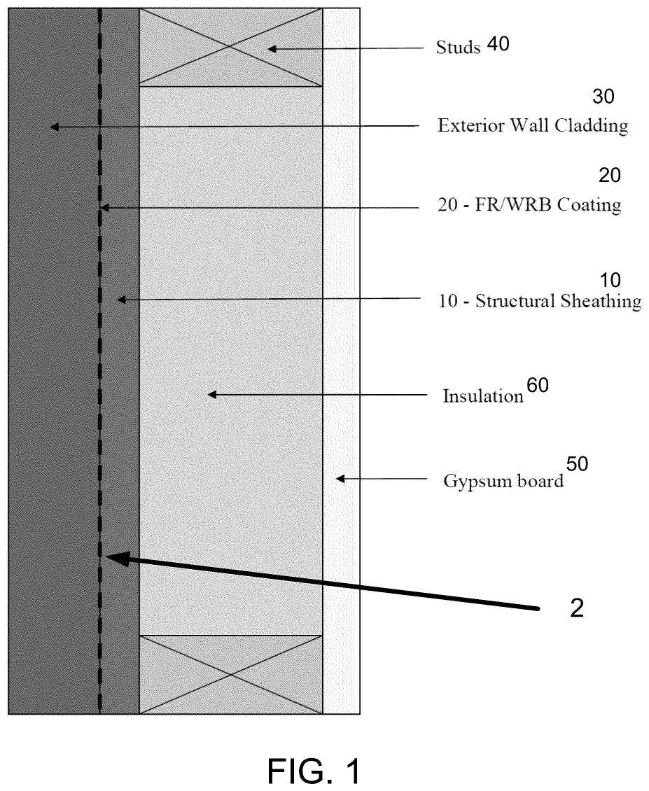

In various exemplary embodiments, as seen in FIG. 1, the present invention comprises a multi-layer panel 2 for use as structural sheathing. The multi-layer panel comprises a wood structural panel 10, such as OSB or plywood, coated or treated with a product that provides both fire resistance and weather/water resistance. The treatment may be a coating layer 20. In various embodiments, the treatment provides fire resistance (FR) as well as acting as a water resistive barrier (WRB). The invention thus combines fire resistance and water resistance in a multi-layer panel product, which is less reliant on skilled labor for installation at a job site and reduces installation time by eliminating the application of a WRB system in the installation process.

Exterior wall cladding 30 is placed over the structural sheathing with the dual FR/WRB coating, which is fastened to studs 40 or structure framing. An interior wall board (such as gypsum board 50) is attached to interior of the structure framing or studs, with some form of insulation material placed therebetween 60.

In contrast to the prior art, where a WRB system is separately applied to FRT sheathing panels at the job site after installation, the present invention applies a joint fire-resistant and water-resistant coating or barrier (FR/WRB) 20 to the panel at the manufacturing facility, prior to shipping or installation at a job site, thereby avoiding the problems noted above with regard to prior art systems.

In one embodiment, a fluid or liquid applied coating or membrane is applied as the FR/WRB 20 via one or more spray nozzles in a manufacturing process. As the panel travels down a secondary production line, the FR/WRB coating is sprayed on the top face of the panel. In some embodiments, the FR/WRB coating also may be applied to the edges of the panel. In some embodiments, the FR/WRB coating is applied to a single face of the panel (i.e., the top face), while in other embodiments, the FR/WRB coating is applied to both faces of the panel.

As a result of this in-line process, the FR/WRB coating is applied at an even, consistent thickness across the panel. In one exemplary embodiment, the FR/WRB coating is applied at a thickness of from approximately 20 mils to approximately 80 mils. In another exemplary embodiment, the FR/WRB coating is applied at a minimum thickness of approximately 5 mils.

In various exemplary embodiments, the fluid or liquid applied FR/WRB comprises an intumescent coating or other fire-resistant coating combining with a polyurea resin, polyurethane resin, epoxy, alkyd, acrylic resins, or combinations thereof.

The applied FR/WRB is substantially bulk water resistant while water vapor permeable, with ratings dependent upon the type of FR/WRB fluid or liquid, and the coating thickness. In several embodiments, the FR/WRB panels of the present invention may be characterized by a minimum water vapor permeance of 5 perms (U.S.) (based on ASTM E96).

After drying, branding or markings, if any, to be applied to the panel are then applied or printed on the coated surface of the desired face, such as by using a digital printer or other stamping process. This marking also may be performed in the manufacturing line.

During installation at a job or construction site, the sheathing panels often are gapped installation according to appropriate guidelines for the structural sheathing (e.g., ⅛″ gapping). The gaps between the panels are then sealed on-site after installation using a sealant means, such as, but not limited to, (1) a fluid applied spray FR/WRB or WRB sealant applied to the gap (which may be the same or similar sealant of similar chemical makeup to the coating applied to the panel face), (2) tape that bridges the gap (e.g., approximately 3″ in width), or (3) self-troweling sealant applied using an electric caulk gun. These sealant means may be water vapor permeable. When installed, the system provides the structure with an integral, monolithic building envelope that functions as an effective water resistive barrier (i.e., resists bulk water) and an effective air barrier system that is vapor permeable, fire-rated and structural.

The present invention possesses several advantages over the prior art. It provides a savings in time and labor, as a secondary contractor is not needed to apply the WRB system after a sheathing panel is installed. Further, coating the panels in a controlled setting (e.g., manufacturing facility) allows the thickness of the coating to be consistently applied, and further allows the coating the opportunity to fully bond with the panel. More specifically, the coating can fully cure independent of weather conditions, and be applied to a clean panel without interference from construction-related dirt, debris or humidity. The present invention also prevents air movement between the FR/WRB layer and the face of the underlying panel. These enhancements increase system performance, installation reliability and structure durability while decreasing construction related waste.

In addition, in one exemplary, the elastomeric properties of the FR/WRB coating allows it to “wrap-around” nails that penetrate the panel. This provides a sealing effect, and is in sharp contrast to prior art housewrap systems, where chipping or tearing often occurs at the point of penetration (thereby compromising the overall integrity of the system). The present system also reduces the amount and number of materials needed to be delivered and stored at a job site.

The FR/WRB material or materials are applied through a spraying or flow coating process. This coating process may comprise applying the FR/WRB coating to the panel, initiating the coating cure in an oven, and completing coating curing in a chamber. The finished product is an OSB panel with one or more FR/WRB coating layers.

In several embodiments, the performance attributes of the coated wood or wood-composite structural panels comprise one or more of the following:

### A. Fire Resistance Performance:

the coated panel has a listed flame spread index of 25 or less according to the applicable ASTM E84 testing standard.
the coated panel meets or exceeds the applicable ASTM E84 test, i.e., for a 20-minute period, the flame front will not progress more than 10.5 feet beyond the centerline of the burners at any time during the test.
the coated panel maintains the above fire performance standards after being subjected to freeze-thaw and/or UV-waterspray and/or elevated temperature exposure as set form in the applicable ICC-ES AC479 testing standard.

### B. WRB Performance:

the coated panel has at least 15 psi flatwise tensile strength between the coating and the wood substrate according to the applicable ASTM C297 testing standard.
the coating is vapor permeable, with a moisture vapor permeance rating of 5 perms or greater according to the applicable ASTM E96 testing standard.
the coated panel meets the several water-penetration test minimum requirements specified in the applicable ICC-ES AC212 testing standard.
the coating maintains water-resistive performance after subjected to 10 freeze-thaw cycles according to ICC-ES AC212 testing standard.
the coating maintains water-resistive performance after being placed in an enclosed chamber containing a heated, saturated mixture of air and water vapor for 14 days according to the applicable ASTM D2247 testing standard.
the coating maintains water-resistive performance after being subjected to the UV exposure and accelerated aging specified in the ICC-ES AC212 testing standard.

Accordingly, in one embodiment, the present invention comprises a structural panel, comprising a base layer with a first surface and a second surface; and a resistance layer covering the first surface; wherein the resistance layer is both fire resistant and bulk water resistant; and wherein the base layer and the resistance layer are pre-formed into an integral panel. The above base layer of the above panel may comprise wood or engineered wood material, such as, but not limited to, oriented-strand board, fiberboard, particleboard, or plywood. The resistance layer may comprise a fire resistant material, such as, but not limited to, non-combustible magnesium oxide, non-combustible fiberglass-reinforced magnesium oxide, graphite, or combinations thereof. The resistance layer may comprise a resin-impregnated paper overlay or a fluid-applied membrane, and may be water vapor permeable, or semi-water vapor permeable. The resistance layer may have a thickness in the range of from approximately 20 mils to approximately 80 mils.

The invention also may comprise method of producing a fire-resistant and water-resistant integrated structural panel in a factory or factory setting, comprising the steps of:
producing wood strands;
treating some or all of the wood strands with chemicals or additives, or both;
forming, in a production line, a mat with one or more layers from said treated wood strands;
applying, in said production line using a production press, heat and pressure to the mat to form a board with a first surface and a second surface; and
applying, in a factory, a first coating to cover the first surface or the second surface of the board, wherein the first coating resistance layer is both fire resistant and bulk water resistant, to form an integrated structural panel.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

1. A structural panel, comprising:
a base layer with a first surface and a second surface; and
a resistance layer covering the first surface;
wherein the resistance layer is both fire resistant and bulk water resistant;
wherein the base layer and the resistance layer are pre-formed into an integral panel.

2. The panel of claim 1, wherein the base layer comprises wood or engineered wood material.

3. The panel of claim 1, wherein the base layer comprises oriented-strand board, fiberboard, particleboard, or plywood.

4. The panel of claim 1, wherein the resistance layer comprises non-combustible magnesium oxide, non-combustible fiberglass-reinforced magnesium oxide, graphite, or combinations thereof.

5. The panel of claim 1, wherein the resistance layer comprises a resin-impregnated paper overlay.

6. The panel of claim 1, further comprising a second resistance layer coating second surface.

7. The panel of claim 1, wherein the resistance layer has a thickness in the range of from approximately 20 mils to approximately 80 mils.

8. The panel of claim 1, wherein the resistance layer comprises a fluid-applied membrane.

9. The panel of claim 1, wherein the resistance layer is water vapor permeable.

10. A structural panel, comprising:
a base layer comprising engineered wood, with a first surface and a second surface; and
a resistance layer covering the first surface;
wherein the resistance layer is both fire resistant and bulk water resistant;
wherein the resistance layer is water vapor permeable
wherein the base layer and the resistance layer are pre-formed into an integral panel;
wherein the resistance layer comprises fire resistant material; and
wherein the resistance layer has a thickness in the range of from approximately 20 mils to approximately 80 mils.

11. The panel of claim 10, wherein the fire resistant material is non-combustible magnesium oxide, non-combustible fiberglass-reinforced magnesium oxide, graphite, or combinations thereof.

12. A method of producing a fire-resistant and water-resistant integrated structural panel, comprising the steps of:
producing wood strands;
treating some or all of the wood strands with chemicals or additives, or both;
forming, in a production line, a mat with one or more layers from said treated wood strands;
applying, in said production line using a production press, heat and pressure to the mat to form a board with a first surface and a second surface; and
applying, in a factory, a first coating to cover the first surface or the second surface of the board, wherein the first coating resistance layer is both fire resistant and bulk water resistant, to form an integrated structural panel.

13. The method of claim 12, wherein the first coating is applied in a thickness of approximately 20 mils.

14. The method of claim 12, wherein the first coating is applied in a thickness of approximately 80 mils.

15. The method of claim 12, wherein the first coating is applied in a thickness in a range of from approximately 20 mils to approximately 80 mils.

16. The method of claim 12, wherein the integrated structural panel has a flame spread index of 25 or less according to the applicable ASTM E84 testing standard.

17. The method of claim 12, wherein the integrated structural panel has a moisture vapor permeance rating of 5 perms or higher according to the applicable ASTM E96 standard.
